(19) United States
(12) Patent Application Publication
(10) Pub. No.: US 2010/0246059 A1
(43) Pub. Date: Sep. 30, 2010

(54) STORAGE DEVICE

(75) Inventor: Keishi SHIMIZU, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/751,905

(22) Filed: Mar. 31, 2010

(30) Foreign Application Priority Data
Mar. 31, 2009 (JP) 2009-086237

(51) Int. Cl. G11B 33/14

(52) U.S. Cl. 360/97.02; G9B/33.035

(57) ABSTRACT

According to an embodiment, a storage device includes a housing configured to contain a magnetic disk storage medium, a drive section configured to rotate the storage medium to store information into the storage medium, an air passage which is defined along an outer peripheral edge of the storage medium between the outer peripheral edge and a wall portion of the housing which faces the outer peripheral edge, receives air produced as the storage medium rotates, and discharges the received air toward an outer peripheral surface of the storage medium, a filter for dust collection in the air passage, and a spoiler located close to at least an air exhaust side of the air passage and extending from the outer peripheral edge side of the storage medium to a region above a recording surface of the storage medium.

### CROSS-REFERENCE TO RELATED APPLICATIONS

This application is based upon and claims the benefit of priority from Japanese Patent Application No. 2009-086237, filed Mar. 31, 2009, the entire contents of which are incorporated herein by reference.

### BACKGROUND

1. Field

One embodiment of the invention relates to a storage device configured to store information into a rotating disk recording medium.

2. Description of the Related Art

In modern storage devices, such as magnetic disk drives, the flying height of a head has been reduced with the increase of recording density. In order to improve the reliability of the storage devices, therefore, it is essential to prevent a head crash that may be caused if dust enters the gap between the head and a disk medium.

To overcome this problem, there is a known technique for dust collection. According to this technique, a disk medium is contained in a sealed housing, and a dust collection filter is mounted in an arbitrary position on the outer periphery of the disk medium that produces airflow as it rotates. Further, the dust collection capacity of the filter depends greatly on the rate at which air passes through the filter. In order to allow more air to pass through the filter (or to increase the flow rate), therefore, some contrivances, such as the use of an air guiding member, have been tried, but with no satisfactory results.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing a magnetic disk drive as a storage device according to an embodiment with its cover removed;

FIG. 2 is an exemplary sectional view typically showing positional relationships between magnetic storage media, a shroud, and a spoiler;

FIG. 3 is an exemplary plan view for illustrating the operation of the spoiler;

FIG. 4 is an exemplary plan view showing a comparative example with no spoiler;

FIG. 5A is an exemplary exploded perspective view showing the spoiler;

FIG. 5B is an exemplary perspective view showing the spoiler in an incorporated state;

FIG. 6 is an exemplary perspective view showing an example of a resin member comprising the shroud and spoiler;

FIG. 7A is an exemplary perspective view showing a resin member according to another embodiment;

FIG. 7B is an exemplary perspective view showing a housing in which the alternative resin member is incorporated;

FIG. 8 is an exemplary perspective view showing dimensions of the spoiler used in each simulation;

FIGS. 9A, 9B, 9C, and 9D are exemplary views showing results of several simulations; and

FIG. 10 is an exemplary diagram showing airflow rates of a circulation filter.

### DETAILED DESCRIPTION

Various embodiments according to the invention will be described hereinafter with reference to the accompanying drawings. In general, according to an aspect of the invention, there is provided a storage device comprising: a housing configured to contain a magnetic disk storage medium; a drive section configured to rotate the storage medium to store information into the storage medium; an air passage which is defined along an outer peripheral edge of the storage medium between the outer peripheral edge and a wall portion of the housing which faces the outer peripheral edge, receives air produced as the storage medium rotates, and discharges the received air toward an outer peripheral surface of the storage medium; a filter for dust collection in the air passage; and a spoiler located close to at least an air exhaust side of the air passage and extending from the outer peripheral edge side of the storage medium to a region above a recording surface of the storage medium.

A magnetic disk drive according to one embodiment of the invention will now be described in detail with reference to the accompanying drawings.

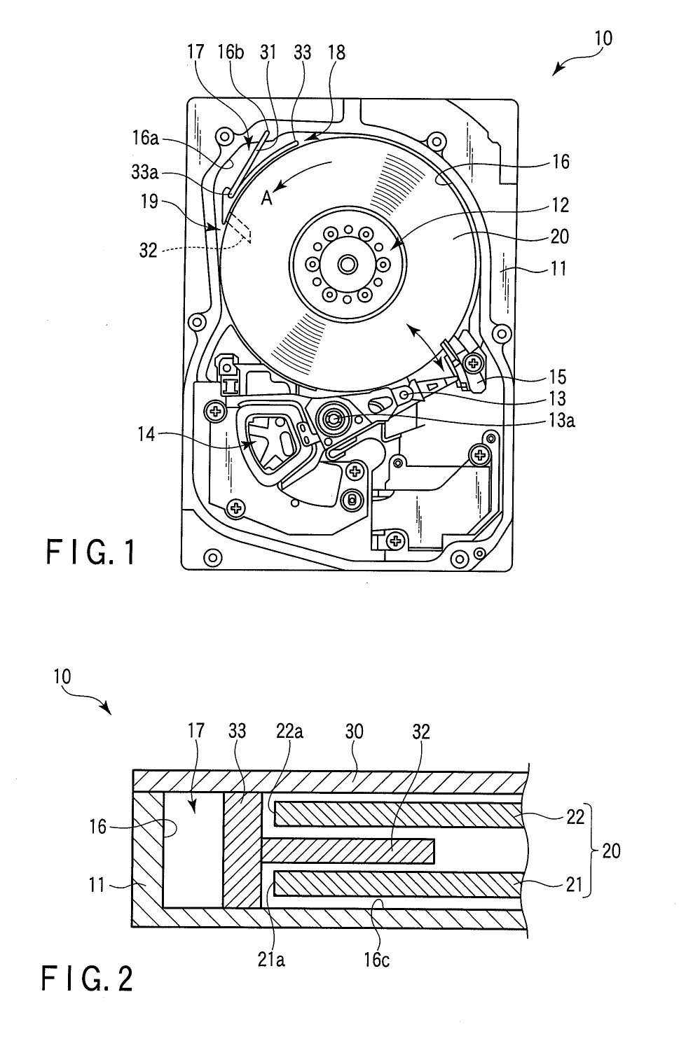

FIG. 1 is a plan view showing a magnetic disk drive 10 as an embodiment of the storage device with its cover removed. The magnetic disk drive 10 comprises a housing 11, and magnetic disk storage media 20 are mounted in a media containing space of the housing 11. The storage media 20 are rotated in the direction of arrow A by a spindle motor 12. A plurality of (e.g., two) magnetic storage media 20 are stacked in a spaced manner and are integrally rotated by the spindle motor 12 that constitutes a drive section.

The magnetic disk drive 10 comprises an arm 13, which is mounted, on its distal end, with a magnetic head (not shown) that writes and reads information to and from each magnetic storage medium 20. On receipt of a driving force from the suspension flexure 14, the arm 13 pivots in the direction of arrow B around a shaft 13a between an unloading position and loading position. In the unloading position, the distal end of the arm 13 is supported by a ramp 15. In the loading position, the magnetic head faces the storage medium 20. When the magnetic head is in the loading position, it writes or reads information to or from the storage medium 20.

The housing 11 of the magnetic disk drive 10 comprises a wall surface 16 that extends along the respective outer peripheral surfaces of the magnetic storage media 20. The wall surface 16, extending along the outer peripheral surfaces of the storage media 20, serves to prevent airflow from being disturbed by the rotation of the media 20.

A part 16a of the wall surface 16 extends away from the respective outer peripheral surfaces of the magnetic storage media 20. A space 17 is defined between the outer peripheral surfaces of the storage media 20 and the wall surface 16 that is spaced apart from the media surfaces. The space 17 accommodates a circulation filter 31. A shroud 33 for circulating air through the circulation filter 31 is located together with the filter 31 in the space 17. The shroud 33 comprises a spoiler 32 that is inserted between the magnetic storage media 20 that are adjacently superposed.

As shown in FIGS. 1 and 2, the shroud 33 is located between an air inlet 18 and air outlet 19 of the space 17, and stands opposite and extends along the outer peripheral surfaces of the magnetic storage media 20. The shroud 33, along with the wall surface 16 of the housing 11, serves to prevent the airflow from being disturbed by the rotation of the storage media 20. Further, the shroud 33 defines the air inlet 18 and outlet 19 on the upstream and downstream sides, respectively, in the direction of rotation A of the storage media 20, between itself and the wall surface 16 of the housing 11 that faces its opposite end portions. The shroud 33 comprises a support groove 33a on its backside for supporting one end of the circulation filter 31.

The opposite end portions of the circulation filter 31 is held in engagement with the support groove 33a of the shroud 33 and a support groove 16b in the wall surface 16 of the housing 11, individually. Thus, the circulation filter 31 is supported so as to block the space 17. Some of air that flows as the magnetic storage medium 20 rotates flows to the backside of the shroud 33 through the air inlet 18, passes through the circulation filter 31, and then flows out through the air outlet 19.

The spoiler 32 is provided on that surface of the shroud 33 which faces the outer peripheral surfaces of the magnetic storage media 20 and is partially located just upstream of the air outlet 19 in the direction of rotation A of the storage media 20. The spoiler 32 extends from the shroud 33, penetrates a gap between the adjacent storage media 20, and is located to face the respective recording surfaces of the storage media.

FIG. 2 is a sectional view typically showing positional relationships between the magnetic storage media 20, shroud 33, and spoiler 32. FIG. 2 also shows a cover 30 of the magnetic disk drive 10.

In this case, the stacked magnetic storage media 20 are two in number. Of these two storage media 20, a lower storage medium 21 is located so close to a bottom surface 16c of the housing 11 that only a slight gap exists between the medium 21 and bottom surface 16c. Further, an upper storage medium 22 of the two media 20 is located so close to the cover 30 that only a small gap exists between the medium 22 and cover 30.

On the other hand, a relatively large gap exists between the two magnetic storage media 21 and 22, and the spoiler 32 penetrates this gap. The shroud 33 extends along respective outer peripheral surfaces 21a and 22a of the storage media 21 and 22 and defines the space 17 on its backside.

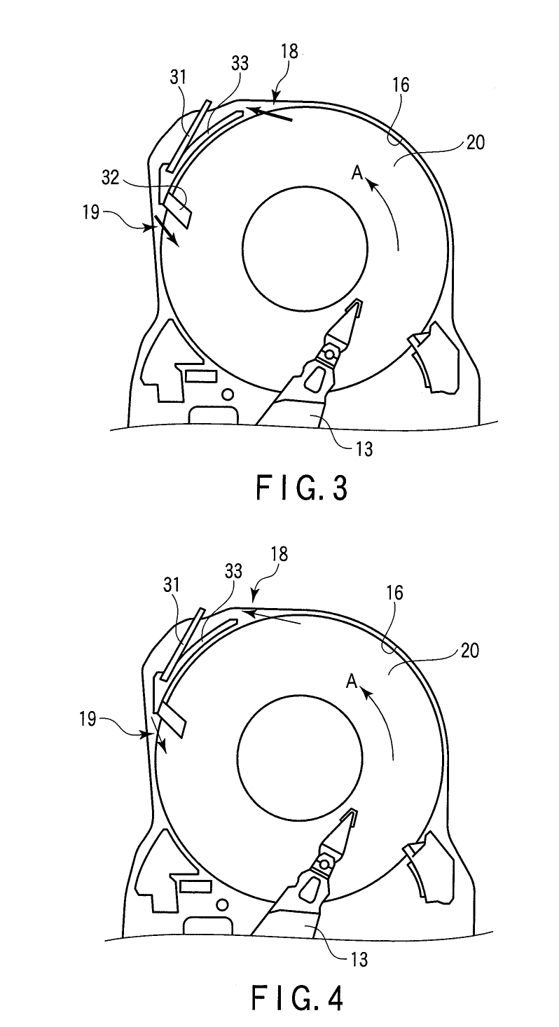

FIG. 3 is a view for illustrating the operation of the spoiler 32, and FIG. 4 is a view showing a comparative example with no spoiler. Without the spoiler 32, as shown in FIG. 4, the difference in pressure between the air inlet 18 and outlet 19 is so small that air passes only at a low flow rate through the circulation filter 31, resulting in a low dust removal efficiency.

In the present embodiment, on the other hand, the shroud 33 comprises the spoiler 32, as shown in FIG. 3. If the spoiler 32 is inserted between the magnetic storage media 21 and 22, a negative pressure is produced on its downstream side. Accordingly, a great pressure difference is produced between the air inlet 18 and outlet 19, so that air enters the backside of the shroud 33 at a high flow rate through the air inlet 18 and passes through the circulation filter 31. This pressure difference, which also depends on the shapes of the spoiler and shroud, is caused by the action of the negative pressure if the aperture ratio of the layer between the storage media 21 and 22 is reduced. Thus, the dust removal efficiency considerably increases.

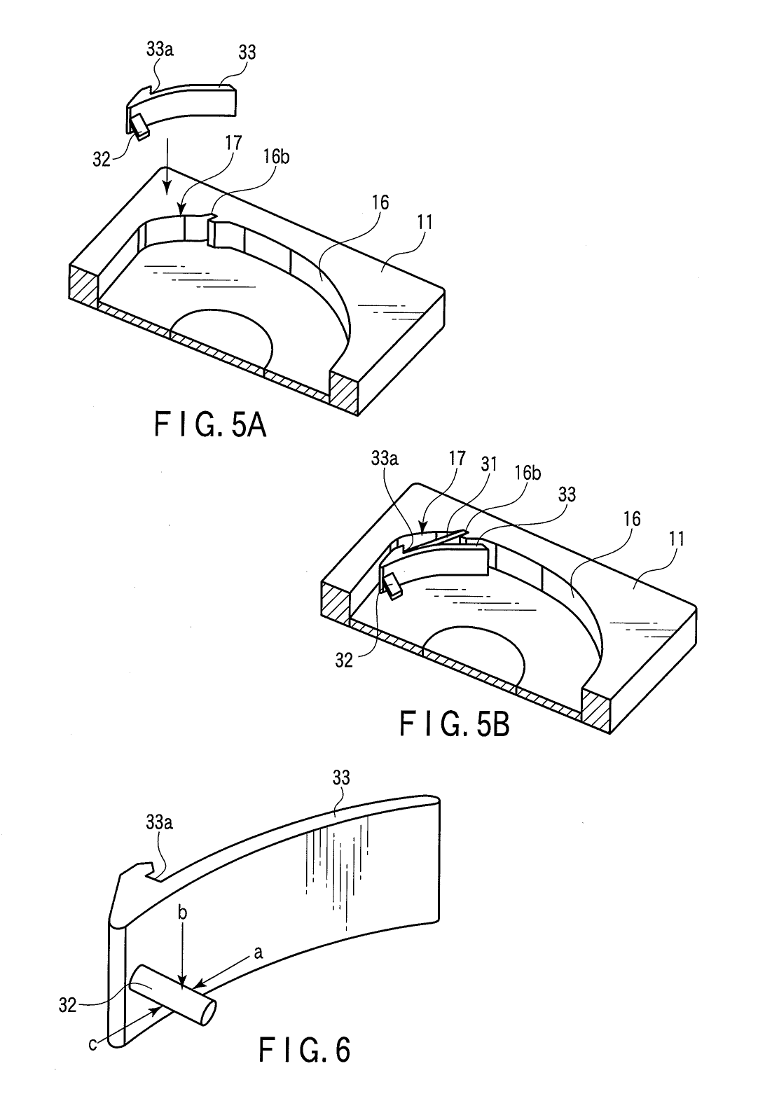

FIGS. 5A and 5B show an example of a filter assembly. In this specification, an assembly that comprises the circulation filter 31, shroud 33, and spoiler 32 is referred to as the filter assembly. As shown in these drawings, the shroud 33 and spoiler 32 form an integral member of a resin material, which is located in the space 17. The circulation filter 31 is supported with its opposite ends inserted individually into the support grooves 33a and 16b in the shroud 33 and the wall surface 16 of the housing 11, respectively. The spoiler 32 is in the form of a plate having a uniform thickness throughout its length and width.

FIG. 6 shows a resin member that is formed of a shroud 33 and spoiler 32 according to another embodiment. The spoiler 32 of this resin member is different in shape from that of the integral member shown in FIG. 5A. The spoiler 32 according to the present embodiment is thinner on the upstream side (indicated by arrow a in FIG. 6) in the direction of rotation A of the magnetic storage media 20. The spoiler 32 is formed of a curved surface (so-called streamline) having its maximum thickness on the way (position indicated by arrow b in FIG. 6) downstream in the direction of rotation A. The thickness of the curved surface is reduced further downstream (indicated by arrow c). If the spoiler 32 is streamlined, airflow can be prevented from being disturbed by its presence without failing to maintain the pressure difference between the air inlet 18 and outlet 19.

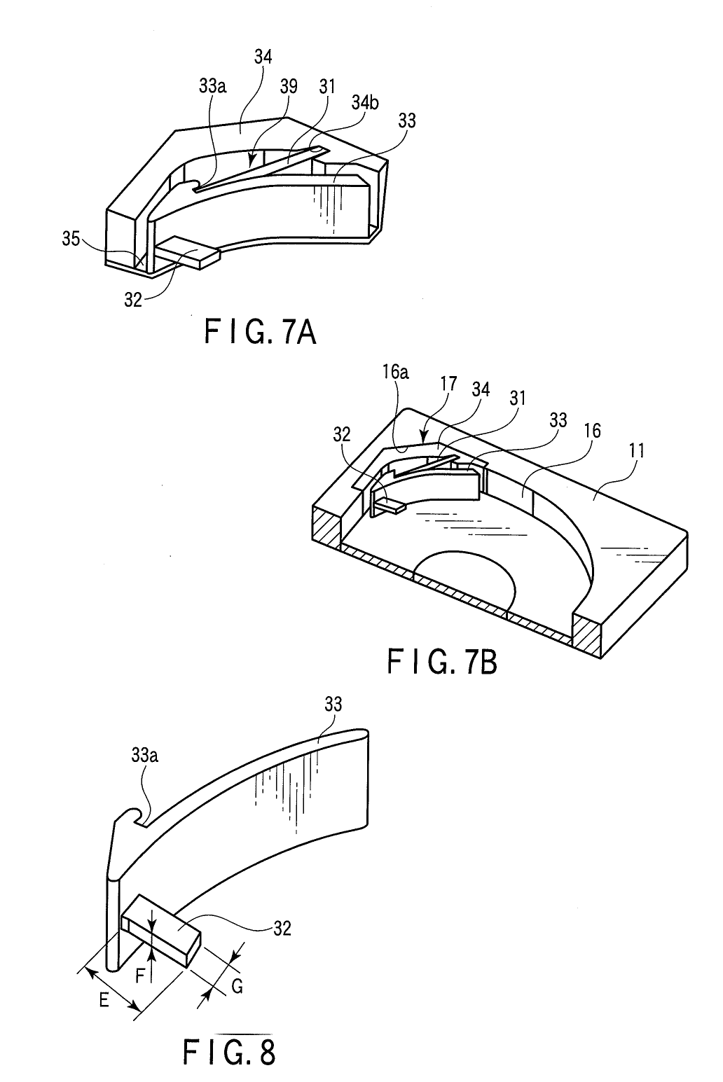

FIGS. 7A and 7B show another example of the filter assembly. This filter assembly comprises a rear-wall block 34 and junction 35, as well as a circulation filter 31, spoiler 32, and shroud 33. The rear-wall block 34 is located on the backside of the shroud 33 so that an air passage is defined between them. Further, the rear-wall block 34 is formed with a support groove 34b, which supports an end of the circulation filter 31. The support groove 34b replaces the support groove 16b in the wall surface 16 of the housing 11 according to the embodiment shown in FIG. 1. The junction 35 connects the shroud 33 and rear-wall block 34.

All the constituent elements of this assembly except the circulation filter 31, that is, the spoiler 32, shroud 33, rear-wall block 34, and junction 35, form a single integral part of a resin material.

As shown in FIG. 7B, a recessed part 16a of a wall surface 16 of a housing 11 that defines a space 17 is just large enough to accommodate the rear-wall block 34. In other words, the space 17 is formed larger than its counterpart of the embodiment shown in FIG. 1 so that the assembly can be just fitted into it.

In the first example shown in FIGS. 5A and 5B, the shroud 33 with the spoiler 32 and the circulation filter 31 are mounted into the housing 11 of the magnetic disk drive 10 in the order named. In the example shown in FIGS. 7A and 7B, on the other hand, the circulation filter 31 is also incorporated in the assembly. In an assembly line for the magnetic disk drive 10, therefore, the assembly should only be mounted in the housing 11. Since the shroud 33 and rear-wall block 34 are integral with each other, moreover, the components can be handled more easily to ensure improved assembling efficiency than in the case where the thin plate-like shroud 33 is handled singly.

The following is a description of results of simulations of operations of the shroud 33 and spoiler 32 for a plurality of comparative examples. FIG. 8 is a view showing dimensions of the shroud 33 and spoiler 32 used in each simulation.

In the simulations, the magnetic storage media 20 were rotated at a speed of 10,000 rpm. Further, a length of projection E of the shroud 33 was adjusted to ⅓ of the radial length of the recording surface of each magnetic storage medium 20, and a width G in the direction of flow to 12.5% of the length of the shroud 33 from the air inlet 18 to the air outlet 19. Furthermore, a thickness F of the shroud 33 was adjusted to 55% of the distance between the respective surfaces of the adjacent magnetic storage media 20.

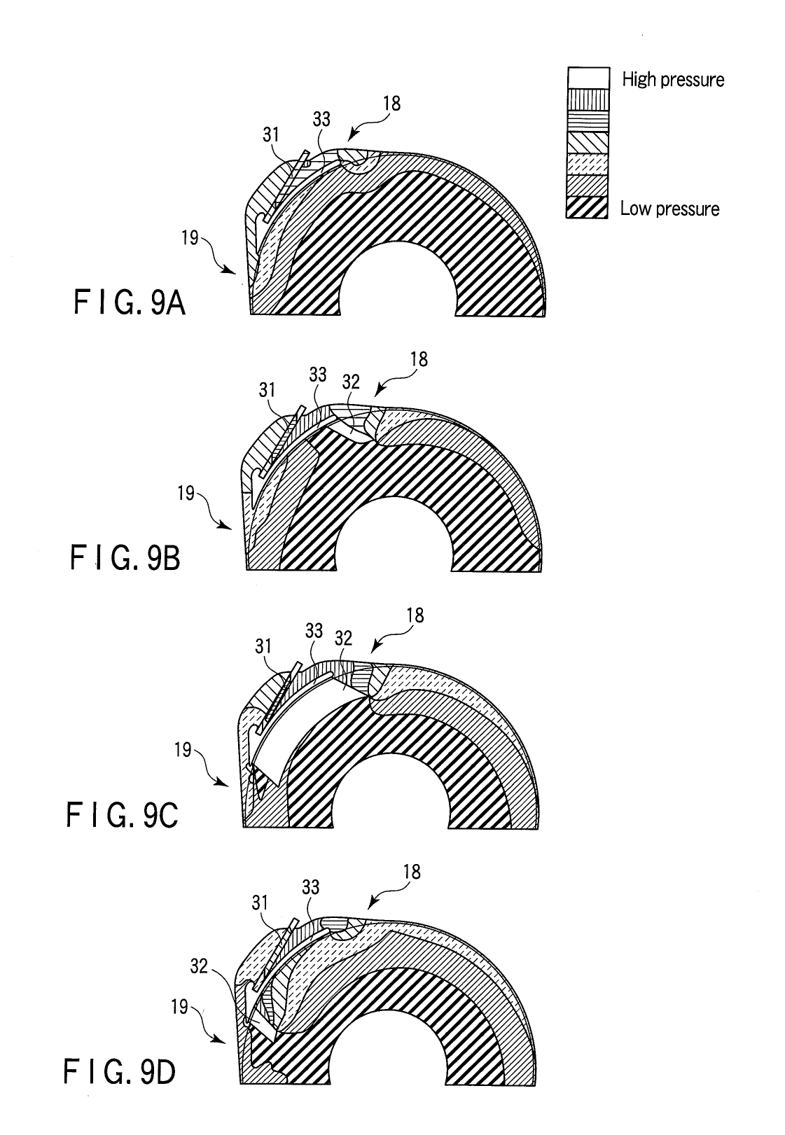

FIGS. 9A, 9B, 9C, and 9D are views showing results of simulations conducted in the conditions described above. FIG. 9A shows a pressure distribution of Comparative Example 1 without the spoiler 32. FIG. 9B shows a pressure distribution of Comparative Example 2 in which the spoiler 32 is provided only on the side of the air inlet 18. FIG. 9C shows a pressure distribution of Example 1 in which the spoiler 32 is disposed covering the overall length of the shroud 33. FIG. 9D shows a pressure distribution of Example 2 in which the spoiler 32 is disposed only on the side of the air outlet 19.

Pressure differences between the sides of the air inlet 18 and outlet 19 in Examples 1 and 2 are greater than those in Comparative Examples 1 and 2. Specifically, in Comparative Example 2 shown in FIG. 9B, a pressure difference is also produced on the side of the air inlet 18 by an increase in forward stagnation pressure by the spoiler 32. This pressure difference is smaller than that produced by a negative-pressure effect of the air outlet 19 of Example 2 shown in FIG. 9D.

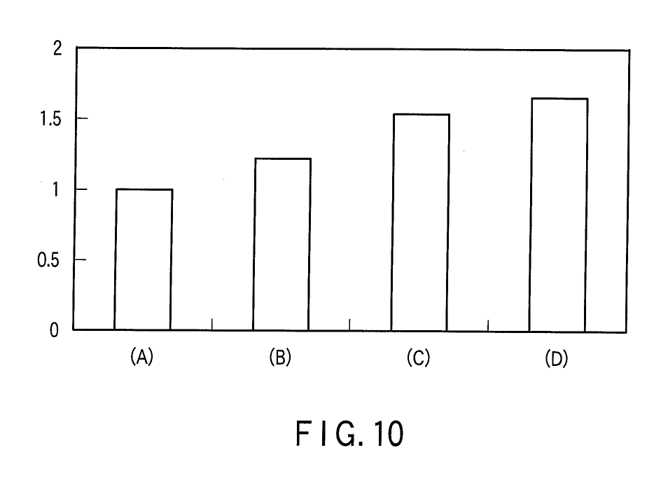

FIG. 10 is a diagram showing airflow rates of the circulation filter 31. Symbols (A) to (D) in FIG. 10 correspond to Comparative Examples 1 and 2 and Examples 1 and 2 shown in FIGS. 9A to 9D, respectively. In this case, FIG. 10 shows airflow rate ratios obtained when the airflow rate for the structure of FIG. 9A (without the spoiler) is standardized as 1.

As seen from FIG. 10, the greater the pressure difference between the air inlet 18 and outlet 19, the higher the airflow rate that can be obtained. Thus, in the configuration in which the spoiler 32 is disposed only on the side of the air outlet 19, as in Example 2 shown in FIG. 9D, the pressure difference attributable to the negative-pressure effect is so great that the airflow rate is maximal.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

In the embodiments described above, the spoiler 32 penetrates the gap between the two magnetic storage media. Alternatively, however, the spoiler 32 may be arranged so as to extend overlapping the bottom side of the lower storage medium (that faces the housing) and the topside of the upper storage medium (that faces the cover). The same functions and effects as those of the above-described embodiments can also be obtained in this case.

Although the magnetic disk drive has been illustrated in connection with the embodiments described herein, moreover, this invention is not limited to the magnetic disk drive, and is widely applicable to any storage devices configured so that a plurality of magnetic disk storage media are rotated in layers.

What is claimed is:

1. A storage device comprising:
a housing;
a magnetic disk storage medium in the housing;
a driver configured to rotate the storage medium;
an air passage between an outer peripheral surface of the storage medium and a wall of the housing which faces the outer peripheral surface, the air passage being configured to circulate air along the outer peripheral surface of the storage medium as the storage medium rotates;
a filter configured to collect dust in the air passage, the filter comprising an air intake side and an air exhaust side; and
a spoiler near the air exhaust side of the filter, between the outer peripheral surface of the storage medium and a region above a recording surface of the storage medium.

2. The storage device of claim 1, further comprising:
a shroud along a portion of the outer peripheral surface of the storage medium; and
a gap between the outer peripheral surface of the storage medium and a side of the shroud which faces the outer peripheral surface, the gap forming a portion of the air passage;
wherein the spoiler extends between the side of the shroud which faces the outer peripheral surface and the region above the recording surface of the storage medium.

3. The storage device of claim 2, wherein the shroud comprises the spoiler.

4. The storage device of claim 2, further comprising:
a filter assembly comprising a rear-wall block, the shroud opposed to the rear-wall block, the spoiler extending from the shroud, a junction connecting the rear-wall block and the shroud, and the filter supported between the rear-wall block and the shroud;
wherein the filter assembly is attached to a wall surface within the housing.

5. The storage device of claim 1, wherein the spoiler comprises a curved surface having an upstream side and a downstream side, and wherein the spoiler is thickest at a point between the upstream side and the downstream side.
